(19) United States
(12) Patent Application Publication
(10) Pub. No.: US 2013/0270961 A1
(43) Pub. Date: Oct. 17, 2013

(54) INTERNAL PERMANENT MAGNET MOTOR

(71) Applicant: MING TSUNG CHU, Taichung City (TW)

(72) Inventor: MING TSUNG CHU, Taichung City (TW)

(21) Appl. No.: 13/447,291

(22) Filed: Apr. 16, 2012

(51) Int. Cl. H02K 1/27

(52) U.S. Cl. 310/216.092

(57) ABSTRACT

An internal permanent magnet motor includes a rotor having main polar surfaces and inter-polar surfaces that are each formed by connecting circular arcs of a plurality of eccentric circles that are not concentric with the rotor center. As such, a technique of adjusting air gap thickness is realized to achieve the purpose of reducing the cogging torque of the motor and regular layered variation of air gap thickness is employed to reduce higher harmonics occurring in the operation of the motor. Further, the present invention uses specific air gap thickness of the inter-polar surfaces and maintaining the inter-polar surfaces at a predetermined width to increase the quadrature axis inductance of the motor in order to increase the reluctance torque of the motor and improve torque of the motor.

### TECHNICAL FIELD OF THE INVENTION

The present invention generally relates to a motor rotor, and more particularly to an internal permanent magnet motor rotor, which increases reluctance torque and reduces cogging torque and higher harmonics.

### DESCRIPTION OF THE PRIOR ART

A conventional internal permanent magnet rotor motor having uniform air gaps adopts a technical solution of reducing main polar surface in order to increase the reluctance torque. Such a technical solution has another meaning of expanding inter-polar surface, increasing inductance ratio between quadrature axis and direct axis, and increasing reluctance torque of motor. However, increasing quadrature axis inductance leads to increase of cogging torque and the cogging torque leads to the generation of pulsation ripple torque, whereby motor may generate vibration and noise. This greatly affects the efficiency of motor, especially for applications of driving vehicle, robot (or manipulator), high precision position control, or constant speed control. The cogging torque must be overcome.

Known technical solutions for improving cogging torque of motor include varying rotor magnet strength, varying magnet development angle, varying manner for magnetizing rotor magnet, forming auxiliary slots in stator teeth, different combination of slot number and pole number, inclined slot of stator and inclined magnetic pole of rotor, reducing width of open slot of stator, and increasing the number of slots of each pole.

A prior art reference, U.S. Pat. No. 6,703,745 B2, discloses a technical solution of using gap reluctance to improve cogging torque. This solution arranges polar surfaces of rotor that opposes magnet slots to be convex circular curves, which will be referred to as circular curve polar surfaces. The radius of the circular curve polar surfaces are shorter than the radius of the rotor. The circular curve polar surfaces change magnetic field distribution of the air gap of the motor so that the magnetic flux in the air gap is distributed in a form close to sinusoidal waves and this improves the cogging torque (see FIG. 1).

However, the above discussed known technical solutions all generate unexpected parasitical effects. For example, in the above mentioned prior art patent, due to the increase of quadrature axis gaps of the motor, the quadrature axis inductances are greatly reduced, and the reluctance torque is also reduced. When the cogging torque is lower than a certain level, the induced voltage may show increased higher harmonics. Particularly, when powerful magnets (such as rare earth magnets) are used, the higher harmonics of the induced voltage may cause pyromagnetic loss of the rotor and stator and increased noise in heavy loading operation of motor. Further, radial force is induced, which makes the rotation torque of the rotor non-uniform and increases loading of bearings. These higher harmonics may further deform the desired sinusoidal magnetic field, causing parasitical torque wave, and this reduces the actual torque output.

It is noted from the above discussion of the prior art techniques that it is not possible to simultaneously achieve reducing cogging torque and increasing reluctance torque and reducing higher harmonics. However, the present invention provides a technical solution that can simultaneously achieve all the three goals.

### SUMMARY OF THE INVENTION

The object of the present invention is to provide an internal permanent magnet motor, which shows the advantages of reducing cogging torque, increasing reluctance torque, and reducing higher harmonics.

To achieve the above technical solution of the present invention, a rotor of motor is arranged to show a contour that forms a plurality of main polar surfaces and inter-polar surfaces. Each of the inter-polar surfaces is located between two adjacent main polar surfaces. The main polar surfaces and the inter-polar surfaces are each composed of circular arc of a plurality of eccentric circles that are not concentric with a center of the rotor center and are connected to each other. The main polar surfaces and the inter-polar surfaces are multi-layered circular arc surfaces, making the air gap between the rotor and the stator non-uniform, but instead showing a regular layered variation. As such, the magnetic flux distribution in the air gap is adjusted to be close to a sinusoidal wave thereby improving the problem of excessive cogging torque. Further, the circular arcs of the main polar surfaces and the inter-polar surfaces form a recess at each connection thereof. The recesses generate air gap magnetic field that suppresses the higher harmonics.

The present invention arranges the inter-polar surface to be at least equal to or greater than a half of the tooth width of tooth of the stator and maintains the width of the inter-polar surface and reduces the air gap of the inter-polar surface in order to obtain increased quadrature axis inductance and thus increasing reluctance torque while maintaining reduced cogging torque.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a rotor and a stator of a conventional motor.

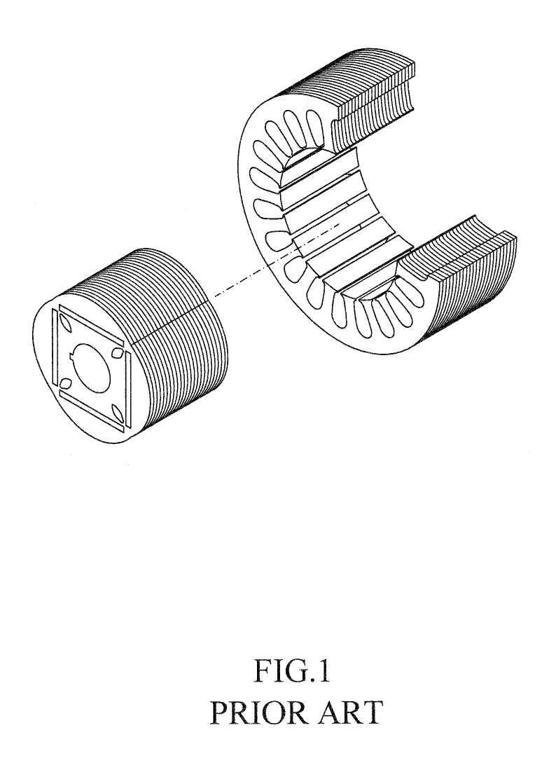

FIG. 2 shows an end view of a rotor and a stator according to the present invention.

FIG. 3 is an enlarged view of a portion of the rotor and the stator according to the present invention, illustrating the shape of a contour of the rotor.

FIG. 4 is an enlarged view of a portion of the rotor and the stator according to the present invention, illustrating conditions that define the contour shape of the rotor.

FIG. 5 shows measurement result of harmonics according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

To explain the essential inventive idea of the present invention, embodiments of the present invention will be described hereinafter. Components or elements of the embodiments are drawn in such a ratio, scale, deformation, and displacement simply for the purposes of easy explanation and understanding of the present invention and may not be of exact scale.

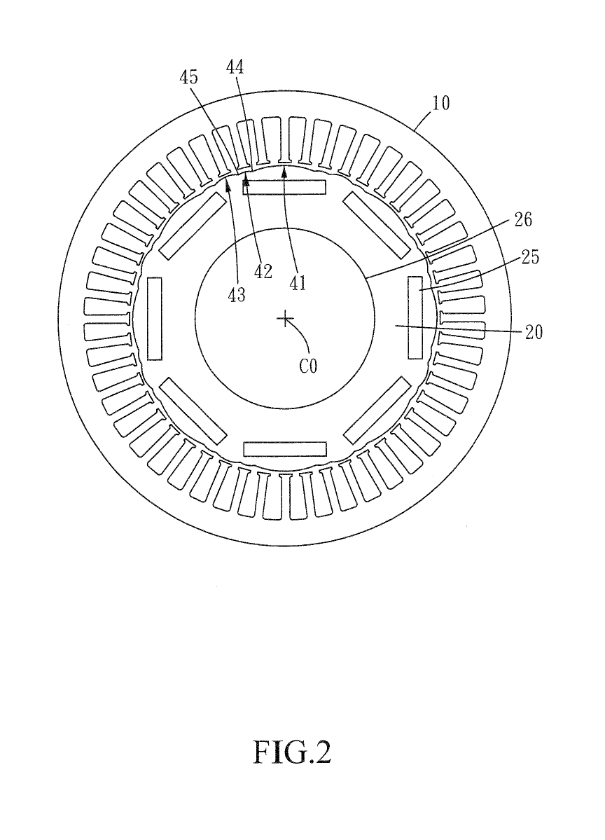

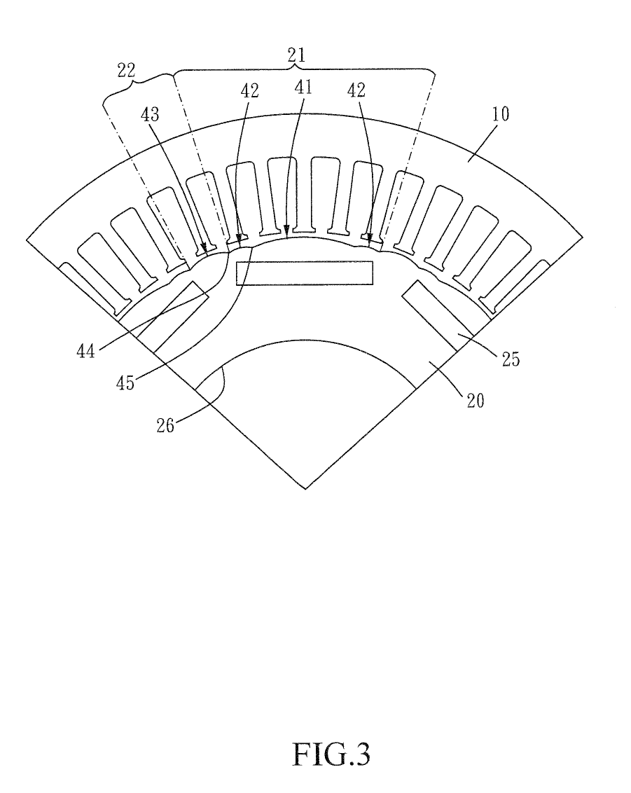

As shown in FIGS. 2 and 3, end views of a stator and a rotor of a motor are provided for description of the present invention, comprising a stator 10, a rotor 20, a plurality of magnet slots 25 that receives permanent magnets mounted therein, and a shaft bore 26 formed in a center of the rotor 20 for receiving a rotation shaft (not shown) therein.

FIG. 3 is an enlarged view of a portion of FIG. 2 and clearly shows an outer contour of the rotor. The invention arranges the outer contour of the motor rotor as a combination of a plurality of main polar surfaces 21 and inter-polar surfaces 22, each inter-polar surface 22 being located between two adjacent main polar surfaces 21. The main polar surfaces 21 and the inter-polar surfaces 22 are each composed of circular arcs of a plurality of eccentric circles that are not concentric with the rotor center C0 and connected to each other. The circular arcs form recess 44, 45 at the connections thereof

The main polar surface 21 is formed by connecting a plurality of eccentric circular arcs that is not concentric with the rotor center C0. In the preferred embodiment of the present invention, the main polar surface 21 comprises a first eccentric circular arc 41 and two second eccentric circular arcs 42. The first eccentric circular arc 41 and the second eccentric circular arcs 42 are not concentric with the rotor center C0 and the first eccentric circular arc 41 and the second eccentric circular arcs 42 are not concentric. The two second eccentric circular arcs 42 are respectively connected to two opposite ends of the first eccentric circular arc 41 and a recess 45 is formed at the connection between the circular arcs.

The inter-polar surface 22 is composed of eccentric circular arcs that are not concentric with the rotor center C0. The inter-polar surface 22 has ends connected to ends of the main polar surface 21. The inter-polar surface 22 can be a single eccentric circular arc or is alternatively formed by connecting a plurality of eccentric circular arcs. In the preferred embodiment of the present invention, the inter-polar surface 22 comprises an eccentric circular arc, which will be referred to as the third eccentric circular arc 43. The second eccentric circular arc 42 is connected to the first eccentric circular arc 41 and the third eccentric circular arc 43, and a recess 44 is formed at the connection between the second eccentric circular arc 42 and the third eccentric circular arc 43.

For easy description, an example that the main polar surface 21 comprises a first eccentric circular arc 41 and two second eccentric circular arc 42 and the inter-polar surface 22 comprises a third eccentric circular arc 43 will be discussed for illustrating the technical feature of the present invention. However, it is noted that the disclosure of the preferred embodiment is not intended to impose undue limitation to the scope of the present invention and variations of the eccentric circular arc number, curvature, and development angle of the eccentric circular arc can be made according to the desired motor performance. For example, the technical feature described below can be modified to suit to uni-directional motor or bi-directional motor.

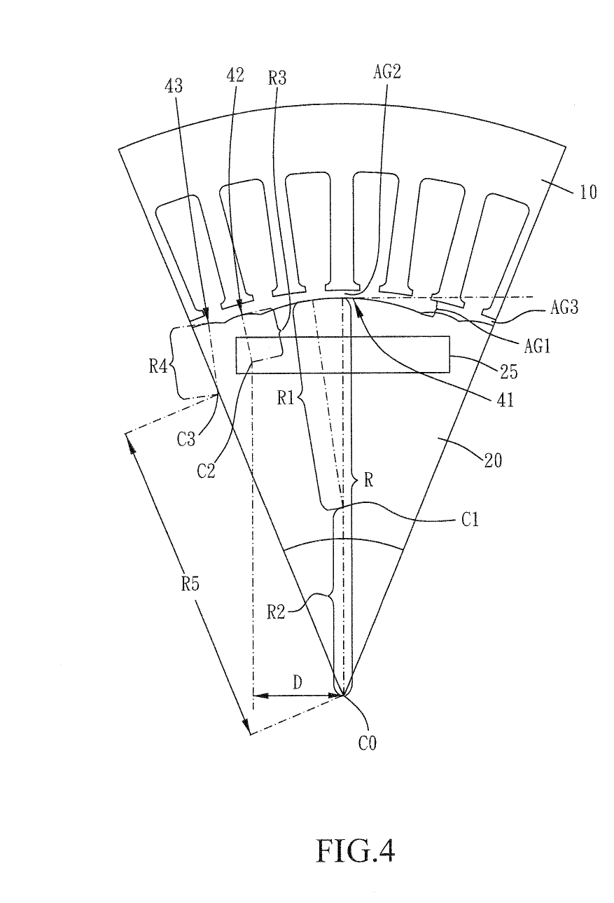

As shown in FIG. 4, the first eccentric circular arc 41 is formed by a first circle center C1 and a first arc radius R1. The first circle center C1 and the rotor center C0 show positional difference of distance R2 therebetween. In a preferred example, the first arc radius R1 is less than the rotor radius R and also shows the relationship of R1+R2=R, but not limited thereto. Alternatively, the first arc radius R1 being greater than the rotor radius R or R2+R=R1 is also feasible. In an application to a unidirectional motor, the first eccentric circular arc 41 can be composed of circular arcs of different centers.

The second eccentric circular arc 42 is formed by a second circle center C2 and a second arc radius R3. The second circle center C2 is shifted from the rotor center C0 by a horizontal distance D. In a preferred example, the second arc radius R3 is less than the rotor radius R, but not limited thereto. It is also feasible to set the second arc radius R3 greater than the rotor radius R. Further, the two second eccentric circular arcs 42 can be of different circular arc radii and not concentric.

The third eccentric circular arc 43 is formed by a third circle center C3 and a third arc radius R4. The third circle center C3 and the rotor center C0 shows a positional difference of distance R5 therebetween. In a preferred example, the third arc radius R4 is less than the rotor radius R and shows the relationship of R4+R5=R, but not limited thereto. It is also feasible to set the third arc radius R4 greater than the rotor radius R, or R5+R=R4.

The total development angle of the first eccentric circular arc 41 and the second eccentric circular arcs 42 of the main polar surface 21 is between (n−m)×(360°/s) and (n−m−1)×(360°/s), wherein n is an integer of total teeth that each main polar surface 21 opposes {int(s/p)}, s is the number of motor slots, p is number of motor poles, m is an integer equal to 0,1,2 . . . . m is an integer and this indicates width of integer number tooth slot that the main polar surface 21 opposes and this causes high cogging torque and must be avoided. Further, (n−m−1) must be greater than zero. The development angle of the first eccentric circular arc 41 is less than 360°/2p (p being the number of poles of motor). Further, a main polar surface 21 and an inter-polar surface 22 contain a first eccentric circular arc 41, two second eccentric circular arc 42, and a third eccentric circular arc 43, of which sum of the development angles thereof is 360°/p (p being the number of poles of motor).

The inter-polar surface 22 is at least equal to or greater than the tooth one half of the width of the tooth of the stator.

The embodiment of the present invention provides a main polar surface that is a combination of a first eccentric circular arc 41 and two second eccentric circular arc 42, so that the air gap thickness AG1 at an end of the main polar surface 21 is greater than the air gap thickness AG2 at a center of circular arc. Preferably, AG1 is 1.2 to 2.5 times of AG2. Further, the air gap thickness AG3 at a center of the inter-polar surface 22 is preferably identical to the air gap thickness AG2 of the center of the main polar surface 21.

The technical features of the present invention have been described above and the effectiveness of the technical feature will be described below.

The present invention arranged the width of the inter-polar surface 22 to be at least equal to or greater than one half of the tooth width of the tooth of the stator and the inter-polar surfaces 22 is formed of the above described third eccentric circular arc 43. This arrangement is to obtain high quadrature axis (Q axis) inductance. The present invention also arranges the center air gap thickness AG3 of the inter-polar surface 22 and the center air gap thickness AG2 of the main polar surface 21 to be identical, reducing the air gap thickness of the inter-polar surfaces 22 to be as small as possible, so as to overcome the problem that excessive air gap leads to reduced Q axis inductance. Based on this, the arrangement of the present invention achieves the purposes of increasing the quadrature axis inductance and increasing reluctance torque of motor.

In achieving the above purposes, the present invention also realizes reduction of cogging torque. According to the present invention, the main polar surface 21 is composed of the first eccentric circular arc 41 and the second eccentric circular arcs 42 and the arrangement of the eccentric circular arcs changes the magnetic field distribution in the air gap, making the magnetic flux distribution in the air gap close to a sinusoidal wave, thereby making the motor showing a reduced cogging torque.

In achieving the reduced cogging torque, the present invention also uses adjustment of the air gap magnetic flux to meet the need of reducing higher harmonics. For example, various arrangements, such as the first eccentric circular arc 41 and the second eccentric circular arc 42 being of different development angles and/or unequal circular arcs, the circular arc eccentricity of the second eccentric circular arc 42 being adjusted, the main polar surface 21 being formed as a multiple-layered circular arc surfaces, a recess 45 being formed at the connection between the first eccentric circular arc 41 and the second eccentric circular arc 42, air gap thickness of the recess 45 being adjusted, may be employed to realize local reduction of the magnetic field that generates higher harmonics (5, 7, 11, 13 . . . order harmonics) so as to minimize the higher harmonics. Due to the reduction of the higher harmonics, the ineffective ripples are reduced and the motor efficiency is improved.

Experiments have been carried out on the preferred embodiment of the present invention in respect of reluctance torque, cogging torque, and harmonics. The results show that the present invention can actually achieve the desired purposes and effectiveness.

### Reluctance Torque

The torque formula of a conventional motor is shown in the following equation (1):

T=3P/Ws[Eq*Iq+(Xd−Xq)*Id*Iq] equation (1)

In which symbol “*” indicates multiplication, T is torque, P is number of motor pole, Ws is synchronous rotational speed, Eq is back electromotive force, Xd is direct axis (d axis) inductance, Xq is quadrature axis (q axis) inductance, Id=−I*sin θ, Iq=I*cos θ, and θ is current angle.

When the magnets of motor rotor are located on surface, Xd=Xq, there being no reluctance torque and torque T being proportional to current Iq. Under the same condition of current I, by controlling the current angle to cause change of Id/Iq current, then the motor rotational speed is increased to generate a rotational speed range in which a characteristic of equal power motor output is provided. In other words, the motor rotational speed is reversely proportional to the output torque and corresponding numeral values of torque and rotational speed are generated.

When the magnet of motor rotor are located inside, Xd<Xq, there being reluctance torque but the torque being not proportional to current Iq. Under the same condition of current I, by adjusting current angle to cause change of Id/Iq current, then reluctance torque can be shown and under the same rotational speed, the torque so obtained is greater than the torque of equal power, thereby making the power increased.

Table 1 shows test data of an 8-pole internal P M (permanent magnet) motor combined with the preferred embodiment of the present invention tested under the same current I and an effectiveness of displaying reluctance torque is obtained.

TABLE 1

| | Values corresponding to | | | Greatest torque at same | | |
|---|---|---|---|---|---|---|
| | equal power of motor | | | currentangle | | |
| Angle θ | Kgf-cm | RPM | W | Kgf-cm | RPM | W |
| 0° | 77.6 | 1750 | 1395 | — | — | — |
| −15° | 75 | 1813 | 1396 | 90 | 1745 | 1612 |
| −30° | 69.6 | 1905 | 1361 | 94 | 1776 | 1714 |
| −45° | 65.6 | 2035 | 1370 | 90.2 | 1919 | 1807 |
| −60° | 57.8 | 2360 | 1400 | 73.4 | 2352 | 1763 |

It can be seen from the greatest torque at same current angle that with respect to the torque of equal power, the torque of motor is substantially increased. 15°

### Cogging Torque

Table 2 shows test data of an 8-pole internal P M (permanent magnet) motor combined with the preferred embodiment of the present invention tested for cogging torque. For the 8-pole motor, each pole takes 45 degrees and thus, repeated cogging torque value will be generated at every 45 degrees. Table 2 lists the value of cogging torque of the motor at different angles.

TABLE 2

| Angle θ | cogging torque kgf-cm |
|---|---|
| 0° | −1.3 |
| 3.2° | −1.0 |
| 6.4° | −0.4 |
| 9.6° | 0.2 |
| 12.8° | 0.8 |
| 16.1° | 1.2 |
| 19.3° | 1.5 |
| 22.5° | 1.4 |
| 25.7° | 1.1 |
| 28.9° | 0.58 |
| 32.1° | −0.2 |
| 35.3° | −0.8 |
| 38.5° | −1.2 |
| 41.7° | −1.4 |
| 45° | −1.2 |

It can be seen from the values of cogging torque listed in Table 2, the maximum value of cogging torque of the motor is 1.5 kgf-cm, and it can be seen from the largest value of torque that when motor reaches the maximum 94 kgf-cm, the maximum cogging torque is only 1.6% with respect to the maximum motor torque. This shows that the present invention indeed provides an advantage of reducing cogging torque.

### Numerical Analysis of Harmonics

After the waveform of back electromotive force of the motor has been measured, each harmonic thereof can be identified through Fourier transformation (FFT). The test is carried out with an 8-pole internal P M (permanent magnet) motor combined with the preferred embodiment of the present invention and a prime mover is employed to drive the test motor to be tested to a rotational speed of 1,500 RPM. The back electromotive force of the motor under test is measured and an oscilloscope is used to carry out FFT analysis of the distribution of harmonics of the back electromotive force.

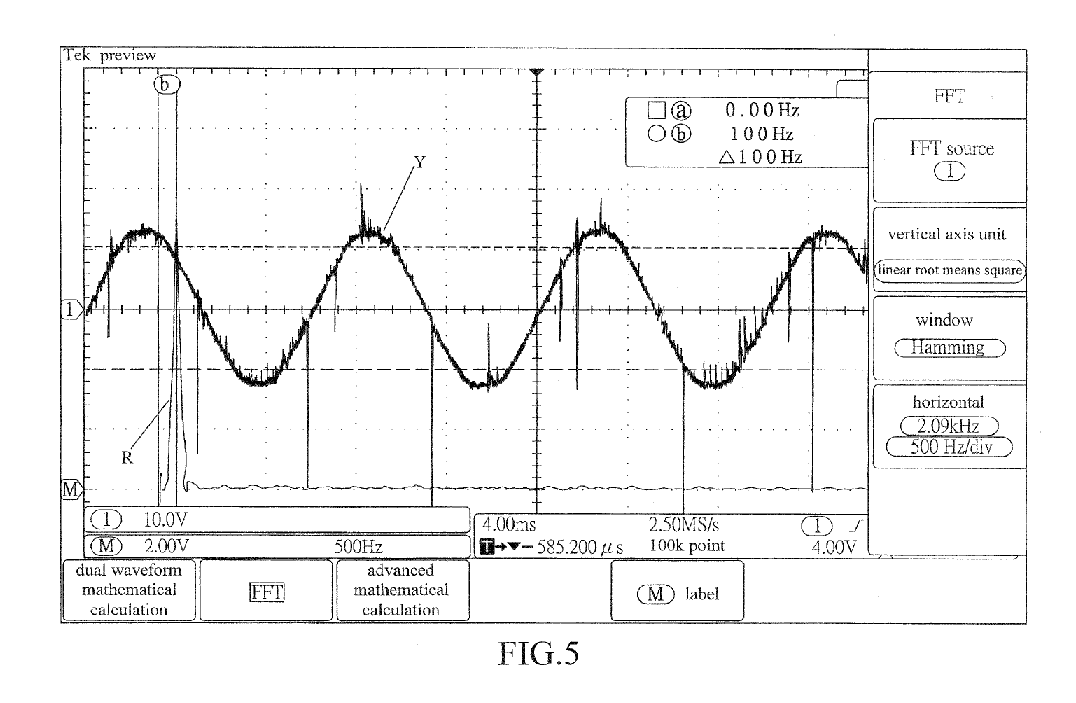

FIG. 5 shows the measurement result of harmonics, in which the curve Y indicates the U-phase back electromotive force of the motor, and the curve R indicates the result of FFT analysis. The FFT result indicates that the primary frequency is only 100 Hz and remaining is zero. This indicates that there is only the fundamental wave and the other harmonics are all almost zero.

Motor rotational speed=120*frequency/pole number of motor

The motor under test has 8 poles and is driven by a prime moves to a rotational speed of 1,500 RPM. Based on the above equation, it can be calculated that the frequency is 100 HZ. This is identical to the result of 100 HZ of the FFT analysis. This shows that the fundamental frequency detected by FFT is exactly the operational frequency of the motor under test. The data of the test show that each harmonic wave is of relatively small percentage as compared to the fundamental wave and this ensures that the present invention is effective in practical applications.

It is known that the higher harmonics are of frequencies that are multiples of that of the fundamental wave. If the oscilloscope shows both the fundamental wave and a number of waveforms of multiple frequencies, then it indicates the existence of the high harmonics. The test result of the present invention shows no waveforms having a frequency that is multiple of 100 Hz and this indicates that there is only the fundamental wave and harmonics are almost zero. This ensures that the present invention can reduce harmonics.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An internal permanent magnet motor, comprising a stator, a rotor, a plurality of magnet slots that receives permanent magnets mounted therein, and a shaft bore formed in a center of the rotor for receiving a rotation shaft therein, the rotor having an outer contour comprising:
a plurality of main polar surfaces and a plurality of inter-polar surfaces, each of the inter-polar surfaces being located between two adjacent main polar surfaces, the main polar surfaces and the inter-polar surfaces being each composed of circular arc of a plurality of eccentric circles that are not concentric with a center of the rotor center and are connected to each other, the circular arcs forming a recess at each connection thereof.

2. The internal permanent magnet motor according to claim 1, wherein the main polar surface has an end that has an air gap thickness that is different from an air gap thickness at a center thereof by 1.2 to 2.5 times.

3. The internal permanent magnet motor according to claim 1, wherein the inter-polar surface has an air gap thickness at a center thereof that is identical to an air gap thickness at the center of the main polar surface.

4. The internal permanent magnet motor according to claim 1, wherein the inter-polar surface has a width that is equal to or greater than a half of tooth width of a tooth of the stator.

5. The internal permanent magnet motor according to claim 1, wherein the main polar surface comprises at least one first eccentric circular arc and at least two second eccentric circular arcs, the first eccentric circular arc and the second eccentric circular arcs being not concentric with the rotor center, the first eccentric circular arc being not concentric with the second eccentric circular arcs, the two second eccentric circular arcs being respectively connected to two ends of the first eccentric circular arc in such a way that a recess is formed at each of the connections of the circular arcs.

6. The internal permanent magnet motor according to claim 5, wherein the first eccentric circular arc is formed by a first circle center and a first arc radius, the first circle center and the rotor center showing a positional difference therebetween.

7. The internal permanent magnet motor according to claim 6, wherein the first arc radius is less than radius of the rotor.

8. The internal permanent magnet motor according to claim 6, wherein the first arc radius is greater than the radius of the rotor.

9. The internal permanent magnet motor according to claim 5, wherein the second eccentric circular arc is formed by a second circle center and a second arc radius, the second circle center being shifted from the rotor center by a horizontal distance.

10. The internal permanent magnet motor according to claim 9, wherein the second arc radius is less than the first arc radius.

11. The internal permanent magnet motor according to claim 9, wherein the second arc radius is greater than the first arc radius.

12. The internal permanent magnet motor according to claim 5, wherein the two second eccentric circles are of different centers and different radii.

13. The internal permanent magnet motor according to claim 5, wherein the main polar surfaces have a total development angle that is between (n−m)×(360°/s) and (n−m−1)×(360°/s), wherein n is an integer of total teeth that each main polar surface opposes {int(s/p)}, s is the number of motor slots, p is number of motor poles, m is an integer equal to 0,1,2 . . . , and n−m−1 is greater than zero.

14. The internal permanent magnet motor according to claim 1, wherein the inter-polar surface comprises at least one eccentric circular arc, the eccentric circular arc of the inter-polar surface being connected to two ends of the main polar surface.

15. The internal permanent magnet motor according to claim 14, wherein the eccentric circular arc of the inter-polar surfaces is formed by a third circle center and a third arc radius, the third circle center and the rotor center showing a positional difference therebetween.

16. The internal permanent magnet motor according to claim 15, wherein the third arc radius is less than the radius of the rotor.

17. The internal permanent magnet motor according to claim 15, wherein the third arc radius is greater than the radius of the rotor.
